(19) United States
(12) Patent Application Publication
(10) Pub. No.: US 2024/0067153 A1
(43) Pub. Date: Feb. 29, 2024

(54) MARITIME MEASUREMENT DEVICE, SYSTEM FOR MEASURING GROUND EFFECT AND AUTOMATICALLY MAINTAINING TRAVEL IN GROUND EFFECT AND VESSEL AUTOMATICALLY REMAINING IN GROUND EFFECT

(71) Applicant: William C Peterson, Leesburg, VA (US)

(72) Inventor: William C Peterson, Leesburg, VA (US)

(21) Appl. No.: 17/896,134

(22) Filed: Aug. 26, 2022

Related U.S. Application Data
(60) Provisional application No. 63/238,086, filed on Aug. 27, 2021.

(51) Int. Cl. B60V 3/08; G05D 1/04

(52) U.S. Cl. CPC B60V 3/08; G05D 1/04

(57) ABSTRACT

A measuring device, method of measuring, and transport vessel including the measuring device measuring the ground effect region for the vessel in real time and controlling the transport vessel, e.g., a Wing In Ground Effect (WIG) vessel, to remain in ground effect based on those measurements. Distance measurement sensors are distributed about the bottom surface of the vessel and communicating sensor signals with a controller during flight. The controller determines the ground effect region for said WIG in real time from the sensor signals and determines WIG transit elevation.

### CROSS REFERENCE TO RELATED APPLICATION

The present application claims benefit to provisional U.S. Application Ser. No. 63/238,086 (Attorney Docket No. FSC-0002-P), “MARITIME MEASUREMENT DEVICE, SYSTEM FOR MEASURING GROUND EFFECT AND AUTOMATICALLY MAINTAINING TRAVEL IN GROUND EFFECT AND VESSEL AUTOMATICALLY REMAINING IN GROUND EFFECT,” filed Aug. 27, 2021, and incorporated herein by reference.

### BACKGROUND OF THE INVENTION

### Field of the Invention

The present invention is related to a measuring device, a method, a control system and autonomous or semi-autonomous multi-platform manned or unmanned vessel, and more particularly, to determining the extent of ground effect in real time and maintaining an autonomous or semi-autonomous manned or unmanned Wing In Ground Effect (WIG) craft or vessel in ground effect during transit.

### Background Description

Though normally aircraft based, a WIG craft or vessel, also called a Ground Effect Vehicle (GEV), is a hybrid, part boat and part aircraft. Wing In Ground Effect (WIG) principles of flight are well known in the art and WIG craft operate under a peculiar aerodynamic phenomenon known as the ground effect. Ground effect occurs at a relatively low altitude where the distance between the wings of a craft and the terrain surface beneath it causes an aerodynamic interaction between the wings and the surface. That aerodynamic interaction creates a cushion of high-pressure air beneath the craft that advantageously increases lift and reduces drag for more efficient/reduced fuel consumption.

However, a typical WIG design combines several difficult issues that have discouraged widespread commercial adoption of WIGs for transportation. Design issues include marine, aviation, wing, air cushion, aerodynamic and hydrodynamic theories in low altitude flight. Further, altitude is measured relative to sea level. Because ground effect occurs at very low altitude, typical altitude measurement instruments are inadequate for determining WIG elevation. Elevation is relative to the terrain surface which varies over waterways in altitude with the tides and weather, e.g., calm seas as opposed to turbulent seas. Since WIGs are designed to operate at low altitude, essentially floating above the surface on a high-pressure air cushion, to take advantage of reduced drag in ground effect; too high elevation (above ground effect) or too low (on the surface) and the WIG frustrates those advantages.

Thus, there is a need for maintaining WIG vessel elevation to remain in ground effect during normal travel.

### SUMMARY OF THE INVENTION

A feature of the invention is maintaining a Wing In Ground Effect (WIG) craft or vessel in ground effect during transit over any terrain;

Another feature of the invention is determining in real time when during transit a WIG approaches leaving ground effect;

Yet another feature of the invention is determining in real time during transit when a WIG begins to fly too low or exceed a ground effect ceiling;

Yet another feature of the invention is a system for determining in real time during transit when a WIG begins to leave ground effect to enable automatically adjusting the WIG flight elevation to remain in ground effect.

The present invention relates to a measuring device measuring the ground effect region for a WIG in real time and controlling the WIG to remain in ground effect based on those measurements.

### BRIEF DESCRIPTION OF THE DRAWINGS

The foregoing and other objects, aspects and advantages will be better understood from the following detailed description of a preferred embodiment of the invention with reference to the drawings, in which:

FIGS. 1A-C show an example of a WIG in top, bottom and side views, respectively, with preferred elevation sensors distributed about the bottom;

FIG. 2 shows an example of a WIG control system;

FIG. 3 shows an example of the WIG operating in ground effect.

### DESCRIPTION OF PREFERRED EMBODIMENTS

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

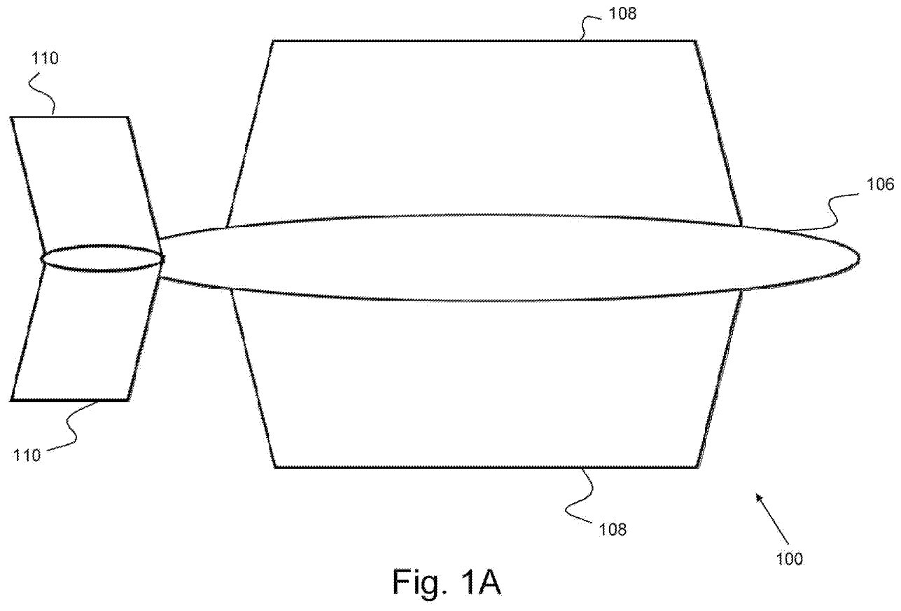

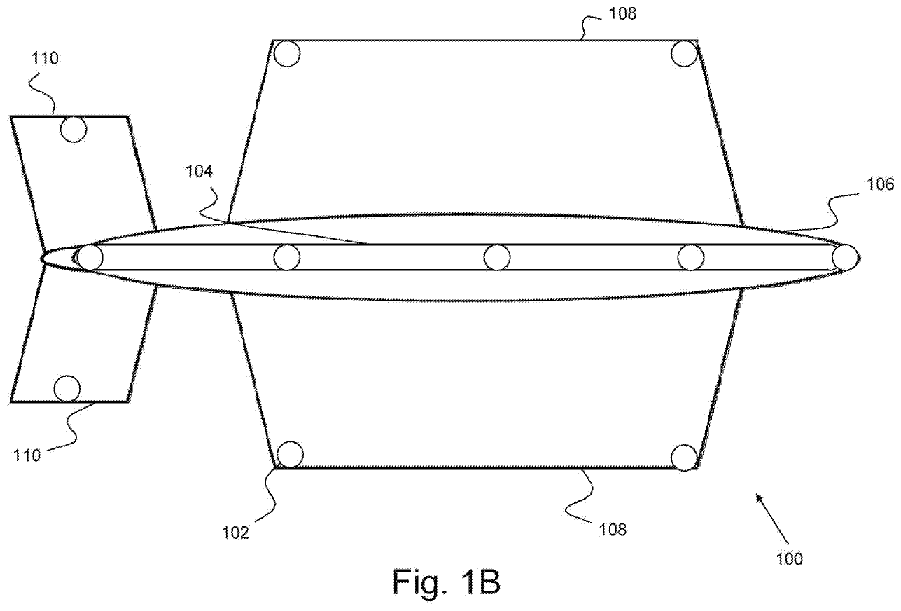

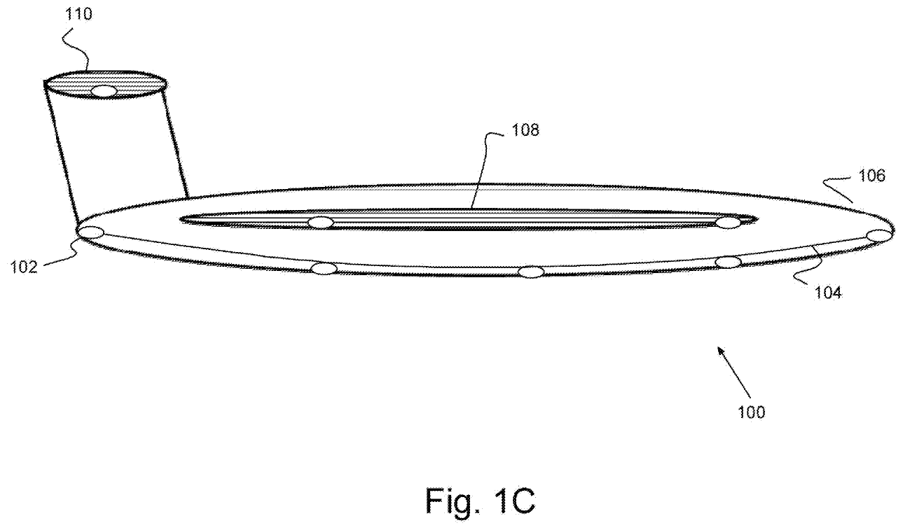

Turning now to the drawings and more particularly, FIGS. 1A-C show an example of a Wing In Ground Effect (WIG) craft or vessel 100 in top, bottom and side views, respectively, with preferred surface distance sensors 102 distributed about the bottom. In this example, surface distance sensors 102 are distributed along the WIG keel 104 at the bottom of the hull or fuselage 106; outboard on both wings 108 fore and aft; and on each horizontal stabilizer 110. The number and location of surface distance sensors 102 in this example is for example only. It is understood that more or fewer surface distance sensors 102 can be used in an array at the same or different locations without departing from the present invention.

Further, the surface distance sensor 102 array may be used on manned or, preferably, unmanned WIG vessels (UWIGs), e.g., autonomously or semi-autonomously (under remote control) transporting cargo over a waterway between a shipping stations or ports (not shown), such as described for example, in Ser. No. 16/460,786 (Attorney Docket No. FSC-0001), “PAYLOAD TRANSPORT AND DELIVERY METHOD, SYSTEM AND MULTI-PLATFORM UNMANNED CARGO DELIVERY VEHICLE,” filed Jul. 2, 2019, published as U.S. Patent Application No. 2020/0010071, and in Ser. No. 17/490,942 (Attorney Docket No. FSC-0001-CIP), “MULTI-PLATFORM UNMANNED CARGO DELIVERY VEHICLE,” filed Sep. 30, 2021, published as U.S. Patent Application No. 2022/0024584, both to William C. Peterson and incorporated herein by reference. It should be noted that craft and vessel are used interchangeably herein unless indicated otherwise, that WIG used herein refers to a WIG craft and UWIG refers to an unmanned WIG.

The International Maritime Organization (IMO) and the International Civil Aviation Organization (ICAO) categorize vessels as type A and B WIG vessels that are incapable of maintaining flight without the support of ground effect and cannot exceed a threshold altitude of 492 feet (150 meters) are licensed as marine vessels and operate under IMO rules in the water or ground effect. WIG vessels that are capable of flight above that threshold altitude are Type C and, therefore, must be licensed by the Federal Aviation Administration (FAA) and are subject to ICAO and FAA rules and regulations.

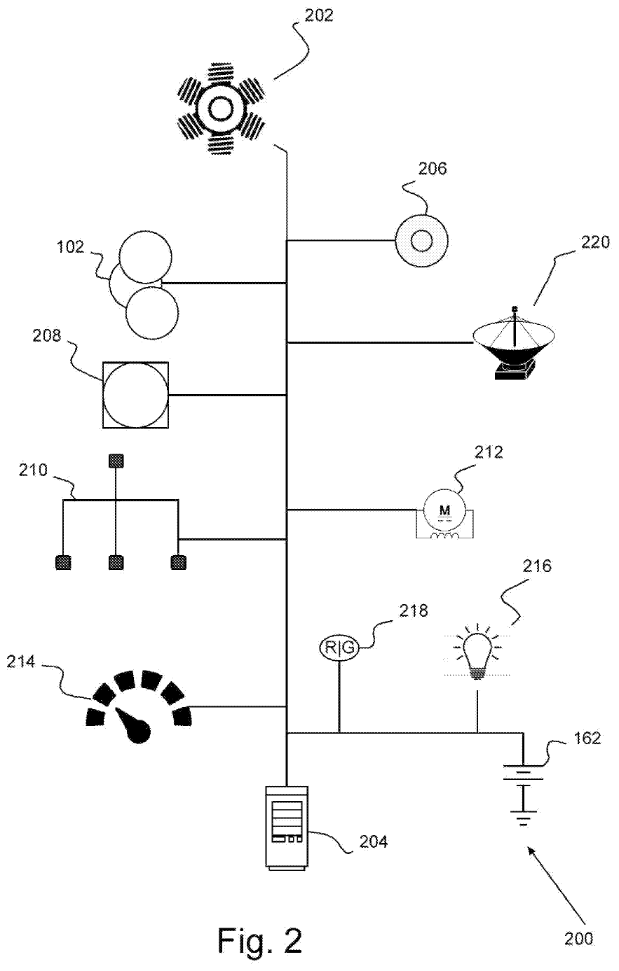

FIG. 2 shows an example of the control system 200 of the WIG 100 of FIGS. 1A-C. A power source, e.g., generator 202, supplies power for on-board controller computer(s) 204 and, where necessary, any other on board electrical equipment, including an array of one or more surface distance sensors 102, flight sensors 206, cameras 208, pneumatic or electric actuators 210 and servos 212, navigational electronics 214, beacons 216, running lights 218, one or more terrestrial and/or satellite transponders 220, e.g., cell or satellite phone based, and may provide a charger for auxiliary 100 kWh power storage batteries/battery pack 222.

The controller, e.g., computer(s) 204, manages the on board electrical equipment, autonomously or semi-autonomously, to control all aspects of WIG 100 operation to stabilize the WIG 100, including controlling roll, flight trim, pitch, yaw and heave, heading and altitude, especially maintaining elevation to keep the WIG 100 in ground effect. Although shown here as a single computer 204, it is understood that control may be distributed to multiple on-board computers for redundancy and/or for cooperatively controlling different aspects of operation, e.g., loading and unloading, flight, navigation and taxiing. Also, as described herein primarily for use over waterways where the surface is dynamic, the present invention may be used over any terrain, static or dynamic, e.g., over land, ice, rivers, marshy swamps, tidal regions or any body of water.

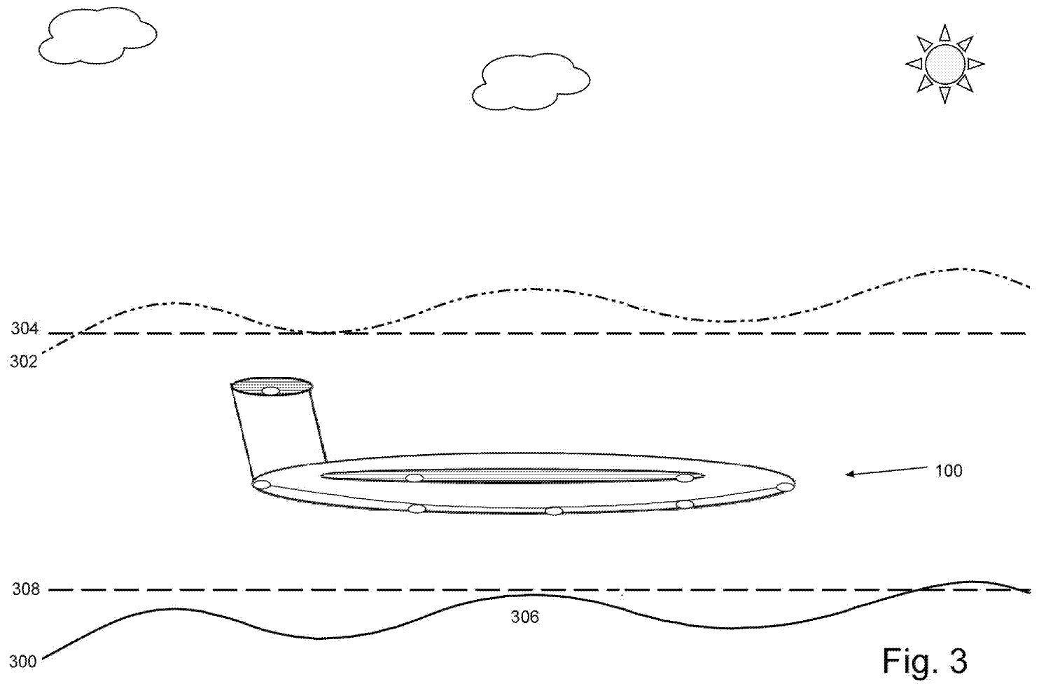

FIG. 3 shows an example of the WIG 100 of FIGS. 1A-C operating in ground effect above a surface 300 of a body of water. In this example, the ground effect ceiling 302 is at half the wingspan above the water surface 300. However, the smooth sailing ceiling 304, the maximum elevation for the WIG 100 for level flight to remain consistently in ground effect, is the bottom of ground effect ceiling 302. Further, just as a ship must maintain leeway from obstacles on her leeward side, the side away from the wind, the WIG 100 must maintain some distance above waves 306, referred to herein as Ground Effect way or GEway 308. So, smooth sailing requires that the WIG 100 remain at or below ground effect ceiling 302 with some minimum of GEway 308. While state of the art altimeters are sufficient for determining when the WIG 100 approaches the Type C altitude threshold, they are inadequate in finding the ground effect ceiling 302, in determining the smooth sailing ceiling 304 or in determining GEway 308.

When a WIG 100 is on the water 300, e.g., taxiing, the water causes significant drag on the WIG 100, causing it to expend substantial energy at a relatively low rate of travel. When the WIG 100 travels above the water in ground effect, induced drag is noticeably lower for substantial energy/fuel savings at a moderately high rate of travel. If the WIG 100 ventures above ground effect ceiling 302 that induced drag increases with a corresponding increase in fuel consumption.

As noted hereinabove, preferred surface distance or elevation sensors 102 are distributed in an array about the underside of the WIG 100. Each preferred surface distance sensor 102 precisely measures the distance to the surface 300 immediately beneath it. The control system, e.g., 200 of FIG. 2, combines these precise distances to characterize the ground effect ceiling 302 in real time with a degree of precision determined by the density of the array of surface distance sensors 102. The control system 200 determines the smooth sailing ceiling 304 from that real time ground effect ceiling 302.

State of the art range finders are designed to use light, e.g., red lasers, to determine the distance to solid, mostly opaque objects at distances to about 1000 meters. Similarly, state of the art laser “tape measures” use red lasers for precisely measuring shorter distances to solid, opaque surfaces. However, over a body of water much of the red light passes through the water surface making measurement results sporadic, and in some cases, measurement accuracy may also depend on weather related factors, e.g., sunlight, cloud cover, rain and time of day. Preferred surface distance sensors 102 sense energy with reflectivity to water maximized for measuring the distance to the surface 300 more reliably and with much less sensitivity to these weather-related factors.

A preferred surface distance sensor 102 array may include active or passive sensors or a combination of active and passive sensors. Active surface distance sensors 102 array may include, for example, laser sensors, InfraRed (IR) laser sensors, ultraViolet (uV) laser sensors, LIDAR sensors, IR LIDAR sensors, uV LIDAR sensors, RADAR sensors, SONAR sensors, or a combination thereof. Passive surface distance sensors 102 may include, for example, video sensors and/or pressure sensors. Video sensors may include, for example, IR video, visible light and/or, uV cameras. Pressure sensors, may include, for example, pitot tube sensors.

Preferably, continually receiving real time surface distance measurements from the surface distance sensor 102 array, control system 200 automatically maps the surface 300 beneath the WIG 100, projects the ground effect ceiling 302 above that surface 300, determines the smooth sailing ceiling 304, and interactively or automatically corrects the WIG 100 elevation for smooth sailing between the surface 300 and smooth sailing ceiling 304. Further, if the WIG 100 is less than a selected minimum GEway 308, e.g., 0.5 meters, there is a potential of the WIG 100 beginning to skip across the waves, to become unwieldy and lose the advantage of reduced ground effect drag. So, if control system 200 determines the WIG 100 has GEway 308 below that minimum, control system 200 interactively or automatically autocorrects, increasing elevation by throttling up or by adjusting WIG control surfaces (not shown), e.g., horizontal stabilizers, thrust vectoring and flaps. Moreover, in the event of high seas with waves taller than half the wingspan in this example, the control system 200 may automatically adjust WIG attitude to follow the surface in ground effect.

Occasionally, some or all of the surface distance sensors 102 may fail to provide data to map the surface 300 sufficiently, e.g., because the WIG 100 is above the range for one or more of the surface distance sensors 102, due to weather related conditions (e.g., sea spray or rain) or because of ambient noise. In these occasions when the surface distance sensors 102 provide insufficient data to map the surface 300 for a selected period of time, e.g., 3 seconds, control system 200 interactively or automatically decreases elevation to resume sensing or until the WIG is on the surface 300, e.g., by throttling down, by adjusting control surfaces or both.

Advantageously, preferred sensors precisely measure terrain surface to sensor distance in real time, even under adverse conditions. A WIG with preferred surface distance sensors mounted at various strategic locations on its lower surface collects real time are measurements of the terrain surface immediately beneath it. A preferred control system automatically maps the terrain surface beneath the WIG with a degree of precision determined by the density of the array of surface distance sensors. The control system uses the surface map interactively or automatically to correct WIG elevation for smooth sailing.

While the invention has been described in terms of preferred embodiments, those skilled in the art will recognize that the invention can be practiced with modification within the spirit and scope of the appended claims. It is intended that all such variations and modifications fall within the scope of the appended claims. Examples and drawings are, accordingly, to be regarded as illustrative rather than restrictive.

What is claimed is:

1. A measuring device comprising:
a plurality of sensors distributed about the bottom surface of a vessel; and
a controller communicating with said plurality of sensors, signals from each sensor indicating the distance directly below the respective sensor to the terrain surface, said controller determining from said signals the vessel elevation above a transit path over said terrain surface.

2. A measuring device as in claim 1, wherein said plurality of sensors comprises at least one active sensor.

3. A measuring device as in claim 2, wherein said at least one active sensor is selected from the group of sensors consisting of laser sensors, InfraRed (IR) laser sensors, ultraViolet (uV) laser sensors, LIDAR sensors, IR LIDAR sensors, uV LIDAR sensors, RADAR sensors and SONAR sensors.

4. A measuring device as in claim 1, wherein said plurality of sensors comprises at least one passive sensor.

5. A measuring device as in claim 4, wherein said at least one passive sensor is selected from the group of sensors consisting of video sensors and pressure sensors.

6. A measuring device as in claim 5, wherein said video sensors are selected from the group of sensors consisting of IR video cameras, visible light cameras and uV cameras.

7. A measuring device as in claim 1, wherein said vessel is a Wing In Ground Effect (WIG) vessel, said controller further determining the ground effect region for said WIG in real time.

8. A measuring device as in claim 7, wherein the terrain is a body of water, said controller further determining a smooth sailing ceiling in said ground effect region in real time.

9. A measuring device as in claim 8, wherein Ground Effect way (GEway) is the elevation above waves and the beginning of said transit path the WIG elevation is selected below said smooth sailing ceiling with at least a selected minimum GEway.

10. A measuring device as in claim 8, said controller further determining from real time WIG elevation whether said WIG is above said smooth sailing ceiling and selectively causing said WIG to adjust elevation to maintain smooth sailing.

11. A method of controlling elevation of a Wing In Ground Effect (WIG) vessel to remain in ground effect during transit, said method comprising:
receiving sensor signals from a plurality of surface distance sensors, each sensor signal indicating the distance to a travel surface directly beneath a respective sensor;
determining a ground effect ceiling responsive to received said sensor signals;
setting travel elevation for said WIG, said travel elevation being above said travel surface and below said ground effect ceiling; and until transit is complete
returning to receiving sensor signals.

12. A method of controlling elevation of a WIG as in claim 11, wherein receiving sensor signals further comprises transmitting energy from one or more of said plurality of surface distance sensors, signals being received by said one or more being return signals responsive to respective transmissions.

13. A method of controlling elevation of a WIG as in claim 11, wherein said travel surface is the surface of a body of water and said ground effect ceiling reflects the contour of the water surface.

14. A method of controlling elevation of a WIG as in claim 13, Ground Effect way (GEway) is WIG elevation above waves, wherein setting said travel elevation comprises:
determining a travel elevation below said ground effect ceiling for smooth sailing as a smooth sailing ceiling;
setting said travel elevation for said WIG a preselected distance below said smooth sailing ceiling with minimum GEway.

15. A method of controlling elevation of a WIG as in claim 11, wherein whenever insufficient sensor signals are received for determining said ground effect ceiling, said method further comprises:
determining the time since the most recent receipt of sufficient sensor signals;
determining whether said time exceeds a selected maximum time;
decreasing travel elevation; and
returning to receiving sensor signals from said plurality of surface distance sensors.

16. A transport vessel for traveling over a body of water, said transport vessel comprising:
a Wing In Ground Effect (WIG) vessel;
a plurality of sensors distributed about the bottom surface of said WIG; and
a controller communicating with said plurality of sensors, signals from each sensor during flight indicating the distance to the surface directly below the respective sensor, said controller determining the ground effect region for said WIG in real time from said signals and further determining WIG elevation during transit.

17. A transport vessel as in claim 16, wherein
Ground Effect way (GEway) is the elevation above waves,
said controller further determining a smooth sailing ceiling in said ground effect region in real time; and
selecting the initial WIG elevation at the beginning of said transit path below said smooth sailing ceiling with at least a selected minimum GEway.

18. A transport vessel as in claim 17, said controller further determining from real time WIG elevation whether said WIG is above said smooth sailing ceiling and selectively causing said WIG to adjust elevation to maintain smooth sailing.

19. A transport vessel as in claim 16, wherein said plurality of sensors comprises at least one active sensor, said at least one active sensor being selected from the group of sensors consisting of laser sensors, InfraRed (IR) laser sensors, ultraViolet (uV) laser sensors, LIDAR sensors, IR LIDAR sensors, uV LIDAR sensors, RADAR sensors and SONAR sensors.

20. A measuring device as in claim 16, wherein said plurality of sensors comprises at least one passive sensor, said at least one passive sensor being selected from the group of sensors consisting of video sensors and pressure sensors.
